(19) United States
(12) Patent Application Publication
(10) Pub. No.: US 2026/0237942 A1
(43) Pub. Date: Aug. 13, 2026

(54) CONNECTOR

(71) Applicant: SUMITOMO WIRING SYSTEMS, LTD., Mie (JP)

(72) Inventors: Kyohei IIDA, Mie (JP); Masashi UCHIDA, Mie (JP)

(21) Appl. No.: 19/153,342

(22) PCT Filed: Jan. 24, 2024
(86) PCT No.: PCT/JP2024/001938

§ 371 Date: Aug. 4, 2025

(30) Foreign Application Priority Data
Feb. 8, 2023 (JP) 2023-017575

(51) Int. Cl. H01R 13/6581; H01R 13/502

(52) U.S. Cl. CPC H01R 13/6581; H01R 13/502

(57) ABSTRACT

A connector (10) includes a shell arrangement part SP in which an electrically conductive shield shell is arrangeable. The shell arrangement part (SP) is provided between an inner housing (40) and an outer housing (50). The inner housing (40) of the connector (10) includes a first tip part (42) for accommodating a terminal (22) of a terminal-equipped wire (20). The outer housing (50) of the connector 10) includes a second tip part (52) for accommodating the first tip part 842). The connector (10) includes a tip part positioning structure (70) for positioning the first tip part (42) with respect to the second tip part (52).

### TECHNICAL FIELD

The present disclosure relates to a connector.

### BACKGROUND

As disclosed in Patent Document 1, a connector is known which is provided with an inner housing for accommodating a terminal-equipped wire. This connector is further provided with an outer housing for accommodating the inner housing and an electrically conductive shield shell arranged between the inner and outer housings. This connector has an electromagnetic shielding function by the shield shell.

### PRIOR ART DOCUMENT

### Patent Document

Patent Document 1: JP 2019-204641 A

### SUMMARY OF THE INVENTION

### Problems to be Solved

In the connector as described above, the arrangement of the shield shell can be omitted if the electromagnetic shielding function by the shield shell is not necessary. In the connector having the arrangement of the shield shell omitted and the connector having the shield shell arranged therein, it is advantageous, for example, in reducing the types of components to commonly use the inner housing and the outer housing. However, if the arrangement of the shield shell is omitted, a gap between the inner and outer housings spreads, wherefore the inner housing easily rattles to be displaced with respect to the outer housing. If such rattling of the inner housing occurs in a tip part of the inner housing accommodating the terminal, smooth connection to a mating connector may, for example, becomes difficult and vibration resistance performance may be reduced in a connected part to the mating connector.

The present disclosure aims to provide a connector capable of suppressing the occurrence of rattling causing a displacement of a tip part of an inner housing with respect to an outer housing regardless of the presence or absence of a shield shell.

### Means to Solve the Problem

The present disclosure is directed to a connector with a terminal-equipped wire including a wire and a terminal to be connected to the wire, an inner housing for accommodating the terminal-equipped wire, an outer housing for accommodating the inner housing, and a shell arrangement part provided between the inner housing and the outer housing, an electrically conductive shield shell being arrangeable in the shell arrangement part, each of the inner housing and the outer housing including an opening making the terminal connectable to a mating terminal, the inner housing including a first tip part for accommodating the terminal of the terminal-equipped wire, the outer housing including a second tip part for accommodating the first tip part, and the connector including a tip part positioning structure for positioning the first tip part with respect to the second tip part.

### Effect of the Invention

According to the connector of the present disclosure, the occurrence of rattling causing a displacement of the tip part of the inner housing with respect to the outer housing can be suppressed regardless of the presence or absence of the shield shell.

### BRIEF DESCRIPTION OF THE DRAWINGS

FIG. 1 is a perspective view showing a connector and a mating connector in one embodiment.

FIG. 2 is an exploded perspective view showing the connector.

FIG. 3 is a section along 3-3 of FIG. 1.

FIG. 4 is a partial front view showing the connector.

FIG. 5 is a section along 5-5 of FIG. 4.

FIG. 6 is a front view showing a lower part of the connector.

FIG. 7 is a section along 7-7 of FIG. 6.

FIG. 8 is a section showing the lower part of the connector.

### DETAILED DESCRIPTION TO EXECUTE THE INVENTION

### Description of Embodiments of Present Disclosure

First, embodiments of the present disclosure are listed and described.
[1] The connector of the present disclosure is provided with a terminal-equipped wire including a wire and a terminal to be connected to the wire, an inner housing for accommodating the terminal-equipped wire, an outer housing for accommodating the inner housing, and a shell arrangement part provided between the inner housing and the outer housing, an electrically conductive shield shell being arrangeable in the shell arrangement part, the inner housing including a first tip part for accommodating the terminal of the terminal-equipped wire, the outer housing including a second tip part for accommodating the first tip part, each of the first tip part and the second tip part including an opening making the terminal connectable to a mating terminal, and the connector including a tip part positioning structure for positioning the first tip part with respect to the second tip part.

According to this configuration, by arranging the shield shell in the shell arrangement part, the connector can be used as a connector with enhanced shielding performance. If a shielding function of the shield shell is not necessary in the connector, the connector can be used without arranging the shield shell in the shell arrangement part. At this time, the first tip part of the inner housing can be positioned with respect to the second tip part of the outer housing by the tip part positioning structure.
[2] In [1] described above, the tip part positioning structure may position the first tip part with respect to the second tip part by a relationship of a recess or through hole and a protrusion to be inserted into the recess or through hole. According to this configuration, for example, the aforementioned positioning accuracy can be easily enhanced.
[3] In [1] or [2] described above, each opening may be open in a direction intersecting an axis of the wire. For example, the above tip part positioning structure can be applied to the connector including such openings.
[4] In [3] described above, the first tip part of the inner housing may include a first tip wall for covering a tip of the terminal by extending to intersect the axis of the wire, the second tip part of the outer housing may include a second tip wall arranged to cover the first tip wall, and the tip part positioning structure may include a structure for positioning the first tip wall with respect to the second tip wall. According to this configuration, the tip part positioning structure can be easily configured, for example, by inserting and assembling the inner housing with the outer housing along the axis of the terminal-equipped wire.
[5] In [3] or [4] described above, a retainer may be further provided which couples the terminal, the first tip part of the inner housing and the second tip part of the outer housing, and the connector may be so configured that the retainer is mountable through the opening of the outer housing. According to this configuration, it can be, for example, maximally avoided that a through hole for mounting the retainer is provided in the outer housing and the shield shell. Thus, it becomes possible to simplify the structure of the outer housing and suppress a reduction in shielding performance when the shield shell is arranged and used.
[6] In any one of [1] to [5] described above, the inner housing may include a first base end part connected to the first tip part, the first base end part accommodating the wire, the outer housing may include a second base end part connected to the second tip part, the second base end part accommodating the first base end part, the connector may include a base end part positioning structure for positioning the first base end part with respect to the second base end part, and the base end part positioning structure may include at least either an inner base end side protrusion provided on the first base end part or an outer base end side protrusion provided on the second base end part and keeps an interval between the first base end part and the second base end part by the base end side protrusion.

According to this configuration, the occurrence of rattling causing a displacement of the first base end part of the inner housing with respect to the second base end part of the outer housing along a direction intersecting the axis of the wire can be more suppressed.
[7] In [6] described above, the base end part positioning structure may include a plurality of the base end side protrusions arranged at different positions along a circumferential direction about an axis of the wire. According to this configuration, the occurrence of rattling causing a displacement of the first base end part of the inner housing with respect to the second base end part of the outer housing along the direction intersecting the axis of the wire can be more suppressed.

### Details of Embodiment of Present Disclosure

A specific example of a connector of the present disclosure is described with reference to the drawings. For the convenience of description, some components may be shown in an exaggerated or simplified manner in each drawing. Further, a dimension ratio of each part may be different in each figure. Note that the present disclosure is not limited to these illustrations, but is represented by claims and intended to include all changes in the scope of claims and in the meaning and scope of equivalents. “Orthogonal” in this specification means not only strictly orthogonal, but also substantially orthogonal within a range in which functions and effects in this embodiment are achieved.

### Overall Configuration of Connector 10

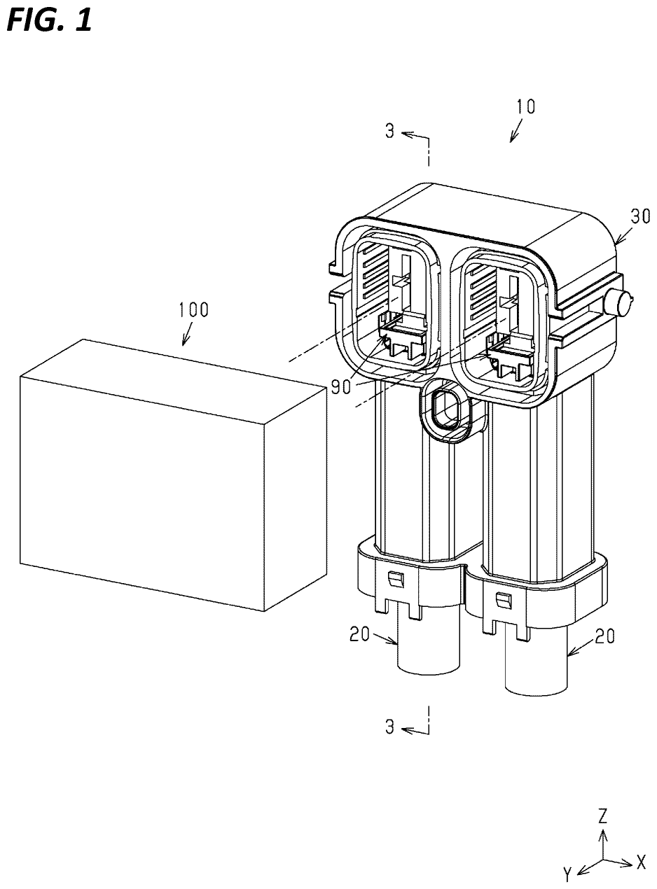

As shown in FIG. 1, a connector 10 is, for example, electrically connected to a mating connector 100 provided on an in-vehicle device such as a motor or an inverter. The mating connector 100 is, for example, provided with two mating terminals and a mating housing for holding the two mating terminals.

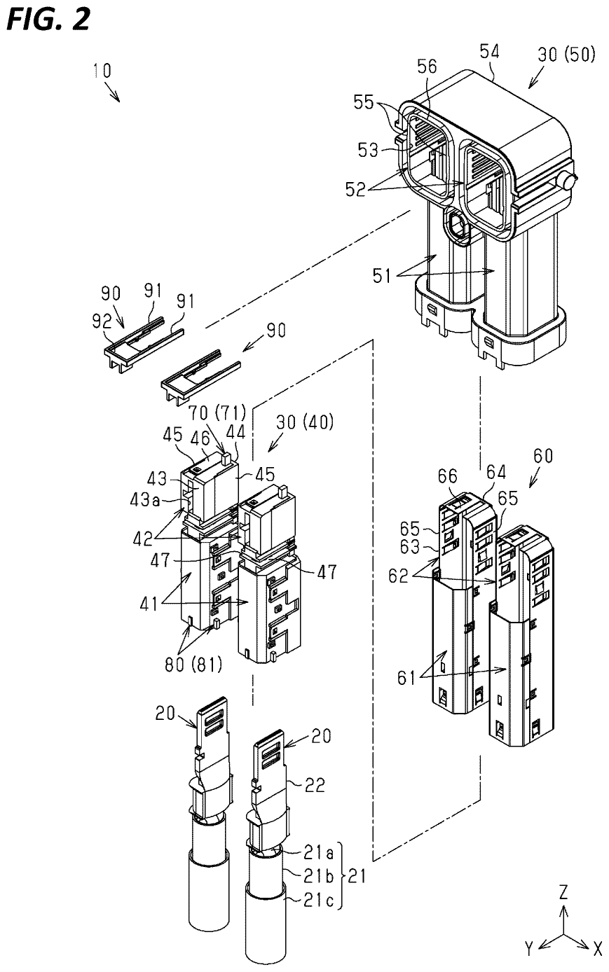

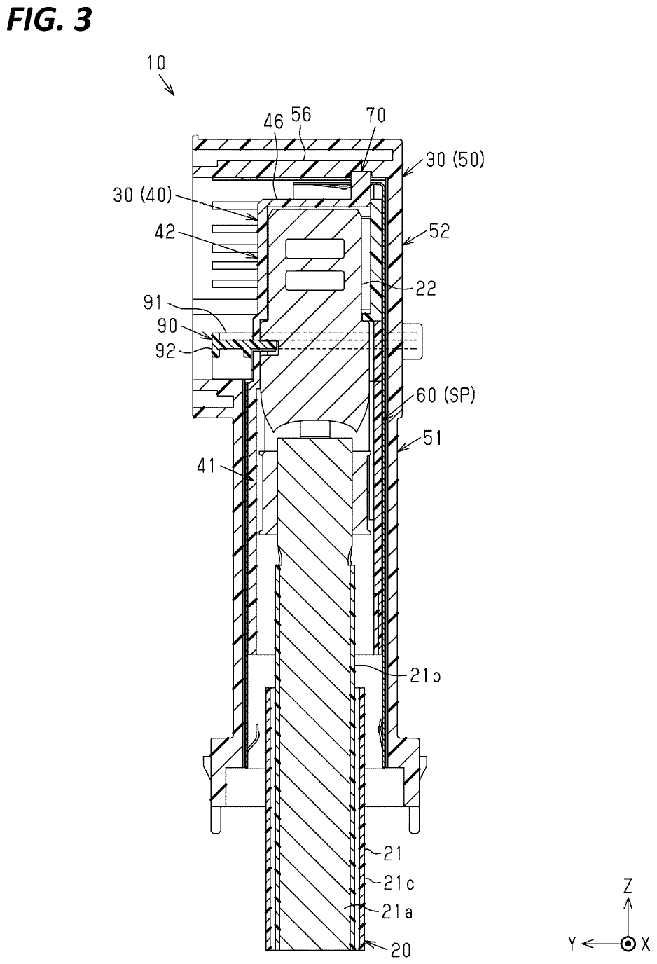

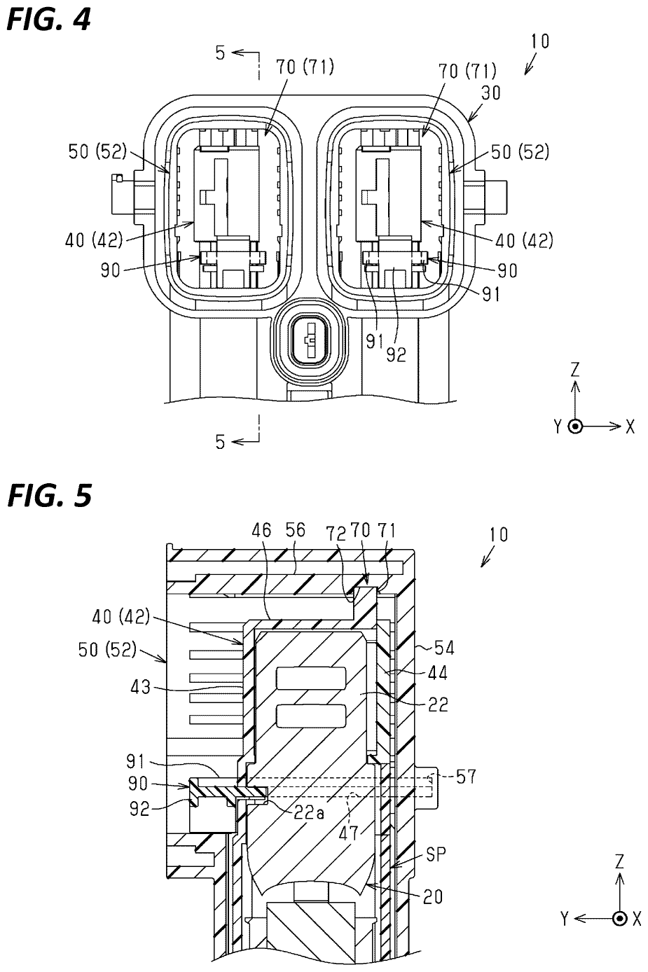

As shown in FIGS. 1 and 2, the connector 10 is provided with two terminal-equipped wires 20 and a housing 30. As shown in FIG. 3, the connector 10 is provided with a shell arrangement part SP in which a shield shell 60 can be arranged. Note that FIGS. 4 to 7 show the connector 10 having the arrangement of the shield shell 60 omitted.

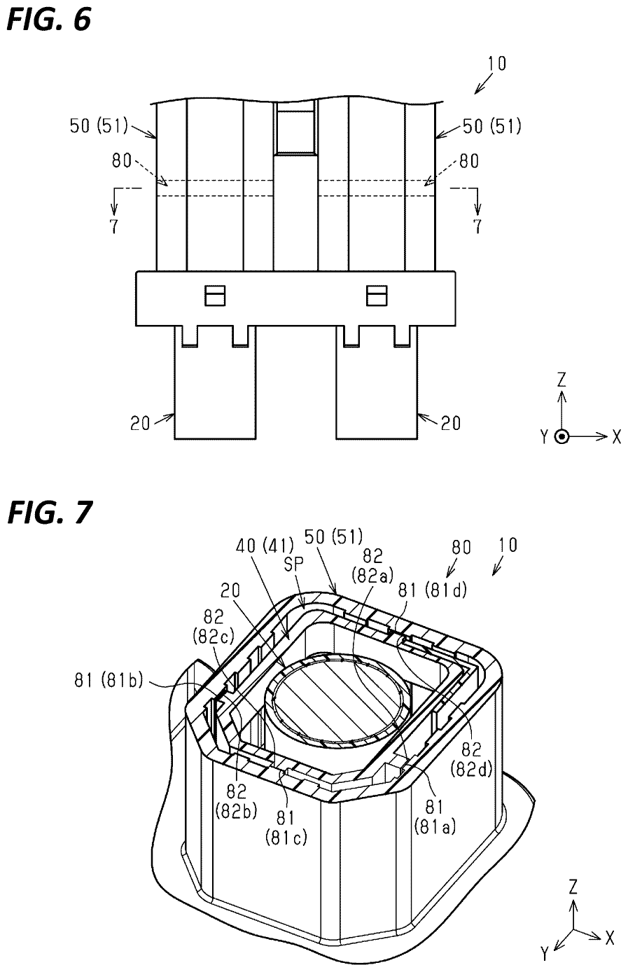

As shown in FIGS. 1 to 3, the connector 10 is provided with tip part positioning structures 70. As shown in FIGS. 6 and 7, the connector 10 is provided with base end part positioning structures 80. As shown in FIGS. 1 to 4, the connector 10 is provided with retainers 90.

XYZ axes orthogonal to each other are shown in figures. The connector 10 is connected to the mating connector 100 along the Y axis. Axes of wires 21 in the two terminal-equipped wires 20 are along the Z axis. The two terminal-equipped wires 20 are arranged along the X axis.

### Configuration of Terminal-Equipped Wire 20

As shown in FIGS. 2 and 3, each terminal-equipped wire 20 includes the wire 21 and a terminal 22 to be connected to the wire 21. The wire 21 includes a core wire 21a, a first insulation coating 21b and a second insulation coating 21c. An unillustrated braided member is arranged between the first and second insulation coatings 21b, 21c.

The first insulation coating 21b covers the outer peripheral surface of the core wire 21a. The braided member covers the outer peripheral surface of the first insulation coating 21b. The second insulation coating 21c covers the outer peripheral surface of the braided member. This wire 21 is a shielded wire. The core wire 21a is, for example, a stranded wire formed by twisting a plurality of metal strands. A copper-based or aluminum-based metal material can be, for example, cited as a material of the core wire 21a. The first insulation coating 21b covers the outer peripheral surface of the core wire 21a over an entire circumference. A resin material mainly containing a polyolefin-based resin such as cross-linked polyethylene or cross-linked polypropylene, polyvinyl chloride (PVC) and the like can be, for example, cited as a material of the first insulation coating 21b. The braided member covers the outer peripheral surface of the first insulation coating 21b over an entire circumference. The braided member is configured by braiding electrically conductive strands into a tubular shape. A copper-based or aluminum-based metal material can be, for example, cited as a material of the braided member.

The second insulation coating 21c covers the outer peripheral surface of the braided member over an entire circumference. A resin material mainly containing a polyolefin-based resin such as cross-linked polyethylene or cross-linked polypropylene can be, for example, cited as a material of the second insulation coating 21c.

The braided member covers the outer peripheral surface of the first insulation coating 21b over the entire circumference. An end part of the core wire 21a is exposed from an end part of the first insulation coating 21b. Note that the wire 21 may be, for example, replaced by a wire including the core wire 21a and an insulation coating covering the outer peripheral surface of the core wire 21a, but including no braided member.

The terminal 22 is electrically connected to the core wire 21a. The terminal 22 is, for example, in the form of a plate extending along a Z-axis direction. A plate thickness direction of the terminal 22 is a direction along the X axis. A copper-based or aluminum-based metal material can be, for example, used as a material of the terminal 22.

The terminal 22 is, for example, connected to the core wire 21a by a connection method such as crimping or ultrasonic welding. By attaching the connector 10 to the mating connector 100, the two terminals 22 of the connector 10 are respectively electrically connected to the two mating terminals of the mating connector 100.

### Configuration of Housing 30

As shown in FIGS. 2 and 3, the housing 30 includes an inner housing 40 and an outer housing 50. The inner housing 40 accommodates the two terminal-equipped wires 20. The outer housing 50 accommodates the inner housing 40. An insulating resin material can be, for example, cited as a material of the inner and outer housings 40, 50.

As shown in FIGS. 2 and 4, the inner housing 40 includes two first base end parts 41 arranged in parallel along the X axis. Each of the two first base end parts 41 has a tubular shape. Each of the two first base end parts 41 accommodates a connected part of the wire 21 and the terminal 22 in the terminal-equipped wire 20.

The inner housing 40 includes two first tip parts 42 arranged in parallel along the X axis. The first tip part 42 is connected to the first base end part 41. The first tip part 42 includes a first front wall 43 arranged to face the mating connector 100. The first front wall 43 includes a first opening 43a, into which the mating terminal of the mating connector 100 is insertable. The first opening 43a is open in a direction intersecting an axis of the wire 21. The first opening 43a is, for example, open in a direction along the Y axis.

As shown in FIGS. 2 and 5, the first tip part 42 includes a first rear wall 44 arranged to face the first front wall 43 and two first side walls 45 connecting the side edges of the first front wall 43 and the first rear wall 44. The first tip part 42 includes a first tip wall 46 for covering the tip of the terminal 22 by extending to intersect the axis of the terminal-equipped wire 20. The first tip wall 46 is, for example, arranged to extend along an XY plane orthogonal to the Z axis. The first tip wall 46 is connected to the first front wall 43, the first rear wall 44 and the two first side walls 45.

As shown in FIG. 2, the outer housing 50 includes two second base end parts 51 arranged in parallel along the X axis. Each of the two second base end parts 51 has a tubular shape. Each of the two second base end parts 51 accommodates the first base end part 41 of the inner housing 40.

The outer housing 50 includes two second tip parts 52 arranged in parallel along the X axis. The second tip part 52 is connected to the second base end part 51. The second tip part 52 includes a second opening 53 open to face the mating connector 100. The second opening 53 is, for example, open in a direction along the Y axis.

The second tip part 52 includes a second rear wall 54 arranged to face the second opening 53 and two second side walls 55 forming the side edges of the second opening 53 and connected to the side edges of the second rear wall 54. As shown in FIGS. 2, 3 and 5, the second tip part 52 includes a second tip wall 56 arranged to cover the first tip wall 46 of the inner housing 40. The second tip wall 56 is connected to the second rear wall 54 and the two second side walls 55.

### Configurations of Shell Arrangement Part SP and Shield Shell 60

As shown in FIGS. 3 and 5, the shell arrangement part SP is provided between the inner and outer housings 40, 50. The shield shell 60 arrangeable in the shell arrangement part SP includes two third base end parts 61 arranged in parallel along the X axis as shown in FIG. 2. Each of the two third base end parts 61 has a tubular shape. Each of the two third base end parts 61 accommodates the first base end part 41.

The shield shell 60 includes two third tip parts 62 arranged in parallel in an X-axis direction. The third tip part 62 is connected to the third base end part 61. The third tip part 62 includes a third opening 63 open to face the mating connector 100. The third opening 63 is, for example, open in a direction along the Y axis.

The third tip part 62 includes a third rear wall 64 arranged to face the third opening 63 and two third side walls 65 forming the side edges of the third opening 63 and connected to the side edges of the third rear wall 64. The third tip part 62 includes a third tip wall 66 arranged to cover the first tip wall 46 of the inner housing 40. The third tip wall 66 is connected to the third rear wall 64 and the two third side walls 65. A copper-based, iron-based or aluminum-based metal material can be, for example, cited as a material of the shield shell 60. The third base end parts 61 of the shield shell 60 can be easily arranged to cover the inner housing 40, for example, by being configured to be divisible into two using a surface along an XZ plane as a dividing surface.

### Tip Part Positioning Structure 70

As shown in FIGS. 2 to 5, the tip part positioning structure 70 positions the first tip part 42 of the inner housing 40 with respect to the second tip part 52 of the outer housing 50. The tip part positioning structure 70 positions the first tip part 42 with respect to the second tip part 52 by a relationship of a recess or through hole and a protrusion to be inserted into the recess or through hole.

The tip part positioning structure 70 includes, for example, a positioning protrusion 71 provided to project outward from the first tip wall 46 of the first tip part 42.

The tip part positioning structure 70 includes, for example, a positioning recess 72 provided in the second tip wall 56 of the second tip part 52 of the outer housing 50. The positioning recess 72 is formed in the inner surface of the second tip wall 56. The positioning protrusion 71 is inserted into the positioning recess 72. Such a positioning recess 72 can be replaced by a positioning through hole, into which the positioning protrusion 71 is inserted.

For example, the positioning protrusion 71 preferably has a column shape such as a polygonal column shape or a cylindrical shape. The shape of the positioning recess 72 can be changed as appropriate according to that of the positioning protrusion 71.

The aforementioned shield shell 60 can be provided with through holes or cuts at positions corresponding to the tip part positioning structures 70. In this way, it can be avoided that the shield shell 60 hinders the arrangement of the tip part positioning structures 70.

### Base End Part Positioning Structure 80

As shown in FIGS. 2 and 6 to 8, the base end part positioning structure 80 positions the first base end part 41 of the inner housing 40 with respect to the second base end part 51 of the outer housing 50. The base end part positioning structure 80 includes inner base end side protrusions 81 provided on the first base end part 41 of the inner housing 40. The base end part positioning structure 80 includes outer base end side protrusions 82 provided on the second base end part 51 of the outer housing 50. The base end part positioning structure 80 keeps an interval between the first and second base end parts 41, 51 by the inner and outer base end side protrusions 81, 82.

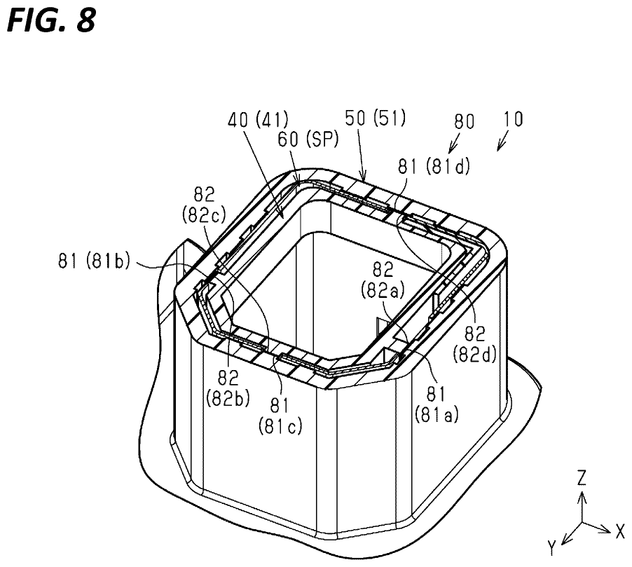

There are a plurality of the inner base end side protrusions 81 arranged at different positions along a circumferential direction about the axis of the wire 21, i.e. a circumferential direction of the first base end part 41. As shown in FIGS. 7 and 8, the inner base end side protrusions 81 include, for example, two first and second inner base end side protrusions 81a, 81b along the X axis and projecting in directions opposite to each other. The inner base end side protrusions 81 include, for example, third and fourth inner base end side protrusions 81c, 81d along the Y axis and projecting in directions opposite to each other.

There are a plurality of the outer base end side protrusions 82 arranged at different positions along the circumferential direction about the axis of the wire 21, i.e. a circumferential direction of the second base end part 51. The outer base end side protrusions 82 include, for example, a first outer base end side protrusion 82a, a second outer base end side protrusion 82b, a third outer base end side protrusion 82c and a fourth outer base end side protrusion 82d.

The first outer base end side protrusion 82a is arranged to be capable of contacting the first inner base end side protrusion 81a. The second outer base end side protrusion 82b is arranged to be capable of contacting the second inner base end side protrusion 81b. The third outer base end side protrusion 82c is arranged to be capable of contacting the third inner base end side protrusion 81c. The fourth outer base end side protrusion 82d is arranged to be capable of contacting the fourth inner base end side protrusion 81d.

The aforementioned shield shell 60 can be provided with through holes or cuts at positions corresponding to the base end part positioning structures 80. In this way, it can be avoided that the shield shell 60 hinders the arrangement of the base end part positioning structures 80.

### Configuration of Retainers 90

As shown in FIGS. 2, 4 and 5, the connector 10 of this embodiment is provided with two retainers 90 to correspond to the two terminals 22. The connector 10 is so configured that the retainers 90 are mountable through the second openings 53 of the outer housing 50.

Each retainer 90 couples the terminal 22, the first tip part 42 of the inner housing 40 and the second tip part 52 of the outer housing 50. Each retainer 90 includes two supporting portions 91 arranged to sandwich the inner housing 40 and a coupling portion 92 coupling the two supporting portions 91. In this way, the terminal 22, the inner housing 40 and the outer housing 50 can be positioned. That is, each retainer 90 restricts relative movements of the terminal 22, the inner housing 40 and the outer housing 50.

As shown in FIG. 5, the terminal 22 includes a coupling portion insertion recess 22a, into which a part of the coupling portion 92 of the retainer 90 is inserted. By inserting a part of the coupling portion 92 of the retainer 90 into the coupling portion insertion recess 22a, a movement of the terminal 22 along the Z axis can be restricted.

As shown in FIG. 2, the inner housing 40 includes two groove portions 47, into which the two supporting portions 91 of each retainer 90 are respectively inserted. Each groove portion 47 is provided to extend along the Y-axis direction. A movement of the inner housing 40 along the Z-axis direction can be restricted by inserting the supporting portions 91 of the retainers 90 into the respective groove portions 47 of the inner housing 40.

As shown in FIG. 5, the second rear wall 54 of the outer housing 50 includes two supporting portion insertion recesses 57, into which the tips of the respective supporting portions 91 of each retainer 90 are respectively inserted. By inserting the tips of the supporting portions 91 respectively into the respective supporting portion insertion recesses 57 of the outer housing 50, the retainer 90 is positioned with respect to the outer housing 50. Such retainers 90 can suppress the terminals 22 and the inner housing 40 from coming out from the outer housing 50 by locking the terminals 22 and the inner housing 40.

### Assembly Method of Connector 10

An example of an assembly method of the connector 10 is described.

To assemble the inner housing 40 with the outer housing 50, the first tip parts 42 of the inner housing 40 are inserted into the second base end parts 51 of the outer housing 50. At this time, the tip part positioning structures 70 can be formed by inserting the positioning protrusions 71 into the positioning recesses. Further, the inner base end side protrusions 81 are arranged to face the outer base end side protrusions 82, whereby the base end part positioning structures 80 can be formed.

After the terminal-equipped wires 20 are arranged in the inner housing 40, the retainers 90 are assembled with the terminals 22, the inner housing 40 and the outer housing 50. At this time, the retainers 90 can be inserted and mounted through the first and second openings 43a, 53.

If the function of the shield shell 60 is necessary in the connector 10, the shield shell 60 can be arranged in the shell arrangement part SP.

Functions of this embodiment are described.

In the aforementioned connector 10, the shield shell 60 is arranged in the shell arrangement part SP, whereby the connector 10 with enhanced shielding performance can be used. On the other hand, if the function of the shield shell 60 is not necessary in the connector 10, the connector 10 can be used without arranging the shield shell 60 in the shell arrangement part SP. At this time, the first tip parts 42 of the inner housing 40 can be positioned with respect to the second tip parts 52 of the outer housing 50 by the tip part positioning structures 70.

### Effects of This Embodiment Are Described

(1) The connector 10 is provided with the terminal-equipped wires 20, the inner housing 40, the outer housing 50 and the shell arrangement part SP. The inner housing 40 includes the first tip parts 42 for accommodating the terminals 22 of the terminal-equipped wires 20. The outer housing 50 includes the second tip parts 52 for accommodating the first tip parts 42. The first tip part 42 includes the first opening 43a making the terminal 22 connectable to the mating terminal. The second tip part 52 includes the second opening 53 making the terminal 22 connectable to the mating terminal. The connector 10 is provided with the tip part positioning structures 70 for positioning the first tip parts 42 with respect to the second tip parts 52.

According to this configuration, the first tip parts 42 of the inner housing 40 can be positioned with respect to the second tip parts 52 of the outer housing 50 as described above. Thus, even in the case of using the connector 10 having the arrangement of the shield shell 60 omitted, it is possible to suppress the occurrence of rattling causing displacements of the first tip parts 42 of the inner housing 40 with respect to the second tip parts 52 of the outer housing 50. That is, regardless of the presence or absence of the shield shell 60, it is possible to suppress the occurrence of rattling causing displacements of the first tip parts 42 of the inner housing 40 with respect to the outer housing 50.

The tip part positioning structure 70 can suppress, for example, the occurrence of rattling causing a displacement of the first tip part 42 of the inner housing 40 with respect to the second tip part 52 of the outer housing 50 along a direction intersecting the axis of the wire 21.
(2) The tip part positioning structure 70 preferably positions the first tip part 42 with respect to the second tip part 52 by a relationship of a recess or through hole and a protrusion to be inserted into the recess or through hole. According to this configuration, for example, the aforementioned positioning accuracy can be easily enhanced. Thus, the aforementioned occurrence of rattling can be more efficiently suppressed.
(3) The first openings 43a of the inner housing 40 and the second openings 53 of the outer housing 50 are open in the direction intersecting the axis of the wire 21. For example, the tip part positioning structures 70 can be applied in the connector 10 including such second openings 53.
(4) The first tip part 42 of the inner housing 40 includes the first tip wall 46 for covering the tip of the terminal 22 by extending to intersect the axis of the wire 21. The second tip part 52 of the outer housing 50 includes the second tip wall 56 arranged to cover the first tip wall 46. The tip part positioning structure 70 is structured to position the first tip wall 46 with respect to the second tip wall 56.

According to this configuration, the tip part positioning structures 70 can be easily configured, for example, by assembling the inner housing 40 with the outer housing 50 along the axes of the wires 21.
(5) The tip part positioning structure 70 for positioning the first tip wall 46 with respect to the second tip wall 56 as described above is preferably configured by a relationship of a recess or through hole and a protrusion to be inserted into the recess or through hole. In this case, for example, a position deviation of the inner housing 40 along the direction intersecting the axis of the wire 20 can be suitably suppressed. Therefore, the aforementioned occurrence of rattling can be more efficiently suppressed.
(6) The connector 10 is provided with the retainers 90 for coupling the terminals 22, the first tip parts 42 of the inner housing 40 and the second tip parts 52 of the outer housing 50. The connector 10 is so configured that the retainers 90 are mountable through the second openings 53 of the outer housing 50. According to this configuration, it can be, for example, maximally avoided that through holes for mounting the retainers 90 are provided in the outer housing 50 and the shield shell 60. Thus, it becomes possible to simplify the structure of the outer housing 50 and suppress a reduction in shielding performance when the shield shell 60 is arranged and used.
(7) The inner housing 40 includes the first base end parts 41 for accommodating the wires 21. The first base end part 41 is connected to the first tip part 42. The outer housing 50 includes the second base end parts 51 for accommodating the first base end parts 41. The second base end part 51 is connected to the second tip part 52. The connector 10 is provided with the base end part positioning structures 80 for positioning the first base end parts 41 with respect to the second base end parts 51. The base end part positioning structure 80 includes the inner base end side protrusions 81 provided on the first base end part 41 and the outer base end side protrusions 82 provided on the second base end part 51. The base end part positioning structure 80 keeps the interval between the first and second base end parts 41, 51 by the inner and outer base end side protrusions 81, 82.

According to this configuration, it is possible to suppress the occurrence of rattling causing a displacement of the first base end part 41 with respect to the second base end part 51 along the direction intersecting the axis of the wire 21 by the base end part positioning structure 80. Therefore, the connector 10 having the arrangement of the shield shell 60 omitted can also be suitably used.
(8) The base end part positioning structure 80 includes the plurality of inner base end side protrusions 81 and the plurality of outer base end side protrusions 82 arranged at the positions different along the circumferential direction about the axis of the wire 21. According to this configuration, it is possible to suppress the occurrence of rattling causing a displacement of the first base end part 41 of the inner housing 40 with respect to the second base end part 51 of the outer housing 50 along the direction intersecting the axis of the wire 21.

### Modifications

This embodiment can be modified and carried out as follows. This embodiment and the following modifications can be combined and carried out without technically contradicting each other.
The base end part positioning structures 80 may be omitted.
The base end part positioning structure 80 may be composed of either the inner base end side protrusions 81 or the outer base end side protrusions 82. In this case, heights of the base end side protrusions may be adjusted as appropriate.
The number of the inner base end side protrusions 81 may be one or more. The number of the outer base end side protrusions 82 may be one or more.
The retainers 90 may be omitted. In this case, it is, for example, possible to provide retainers to be mounted through wall portions other than the second openings 53 of the outer housing 50. Even with such retainers, the terminals 22, the first tip parts 42 of the inner housing 40 and the second tip parts 52 of the outer housing 50 can be coupled.
The tip part positioning structure 70 may be structured to position the tip part in one location or may be structured to position the tip part in two or more locations.
The tip part positioning structure 70 is not limited to a structure for positioning the first tip wall 46 with respect to the second tip wall 56 and, for example, may be structured to position the first rear wall 44 with respect to the second rear wall 54. Further, the tip part positioning structure 70 may be, for example, structured to position the first side walls 45 with respect to the second side walls 55. Further, the tip part positioning structure 70 can be configured by combining a plurality of such structures.
In the tip part positioning structure 70, the positioning protrusion 71 may be provided on the second tip part 52 of the outer housing 50 and the positioning recess 72 may be provided in the first tip part 42 of the inner housing 40.
The tip part positioning structure 70 may be configured to position the first tip part 42 with respect to the second tip part 52 by a relationship of a protrusion and a protrusion for contacting the former protrusion. For example, the positioning recess 72 of the tip part positioning structure 70 may be omitted, and a second positioning protrusion capable of contacting the side surface of the positioning protrusion 71 may be provided on the second tip wall 56 of the second tip part 52 of the outer housing 50. Further, the tip part positioning structure 70 may be, for example, structured to keep the interval between the first and second tip parts 42, 52 by protrusions like the base end part positioning structure 80. Even in this case, the occurrence of rattling causing a displacement of the first tip part 42 with respect to the second tip part 52 can be suppressed by positioning the first tip part 42 with respect to the second tip part 52.

That is, the tip part positioning structure 70 can be configured by combining different structures as described above.
Although the first and second openings 43a, 53 of the above connector 10 are open in the direction intersecting the axis of the wire 21, the opening direction may be changed to a direction along the axis of the wire 21. The connector of this modification is connected to the mating connector 100 along the axial directions of the wires 21.
The number of the terminal-equipped wires 20 may be one or may be two or more.
As in the non-limiting embodiment shown in FIG. 5, an insertion direction of the positioning protrusion 71 into the positioning recess 72 or a projecting direction of the positioning protrusion 71 may be the same as the axis of the wire 21 or a longitudinal direction (Z) of the terminal 22 and may be orthogonal to a connection direction (Y) of the connector 10 and the mating connector 100.

### LIST OF REFERENCE NUMERALS

10 connector
20 terminal-equipped wire
21 wire
21a core wire
21b first insulation coating
21c second insulation coating
22 terminal
22a coupling portion insertion recess
30 housing
40 inner housing
41 first base end part
42 first tip part
43 first front wall
43a first opening
44 first rear wall
45 first side wall
46 first tip wall
47 groove portion
50 outer housing
51 second base end part
52 second tip part
53 second opening
54 second rear wall
54a first supporting portion insertion recess
54b second supporting portion insertion recess
55 second side wall
56 second tip wall
57 insertion recess
60 shield shell
61 third base end part
62 third tip part
63 third opening
64 third rear wall
65 third side wall
66 third tip wall
70 tip part positioning structure
71 positioning protrusion
72 positioning recess
80 base end part positioning structure
81 inner base end side protrusion
81a first inner base end side protrusion
81b second inner base end side protrusion
81c third inner base end side protrusion
81d fourth inner base end side protrusion
82 outer base end side protrusion
82a first outer base end side protrusion
82b second outer base end side protrusion
82c third outer base end side protrusion
82d fourth outer base end side protrusion
90 retainer
91 supporting portion
92 coupling portion
100 mating connector
SP shell arrangement part

1. A connector, comprising:
a terminal-equipped wire including a wire and a terminal to be connected to the wire;
an inner housing for accommodating the terminal-equipped wire;
an outer housing for accommodating the inner housing; and
a shell arrangement part provided between the inner housing and the outer housing, an electrically conductive shield shell being arrangeable in the shell arrangement part,
the inner housing including a first tip part for accommodating the terminal of the terminal-equipped wire,
the outer housing including a second tip part for accommodating the first tip part,
each of the first tip part and the second tip part including an opening making the terminal connectable to a mating terminal, and
the connector comprising a tip part positioning structure for positioning the first tip part with respect to the second tip part.

2. The connector according to claim 1, wherein the tip part positioning structure positions the first tip part with respect to the second tip part by a relationship of a recess or through hole and a protrusion to be inserted into the recess or through hole.

3. The connector according to claim 1, wherein each opening is open in a direction intersecting an axis of the wire.

4. The connector according to claim 3, wherein:
the first tip part of the inner housing includes a first tip wall for covering a tip of the terminal by extending to intersect the axis of the wire,
the second tip part of the outer housing includes a second tip wall arranged to cover the first tip wall, and
the tip part positioning structure includes a structure for positioning the first tip wall with respect to the second tip wall.

5. The connector according to claim 3, further comprising a retainer for coupling the terminal, the first tip part of the inner housing and the second tip part of the outer housing, wherein:
the connector is so configured that the retainer is mountable through the opening of the outer housing.

6. The connector according to claim 1 wherein:
the inner housing includes a first base end part connected to the first tip part, the first base end part accommodating the wire,
the outer housing includes a second base end part connected to the second tip part, the second base end part accommodating the first base end part,
the connector comprises a base end part positioning structure for positioning the first base end part with respect to the second base end part, and
the base end part positioning structure includes at least either an inner base end side protrusion provided on the first base end part or an outer base end side protrusion provided on the second base end part and keeps an interval between the first base end part and the second base end part by the base end side protrusion.

7. The connector according to claim 6, wherein the base end part positioning structure includes a plurality of the base end side protrusions arranged at different positions along a circumferential direction about an axis of the wire.
